(19) United States
(12) Patent Application Publication
(10) Pub. No.: US 2015/0338684 A1
(43) Pub. Date: Nov. 26, 2015

(54) SPRING CLIP ATTACHABLE TO AN EYEGLASS FRAME TEMPLE PIECE

(71) Applicant: John Marshall Steiner, Orem, UT (US)

(72) Inventor: John Marshall Steiner, Orem, UT (US)

(21) Appl. No.: 14/718,080

(22) Filed: May 20, 2015

Related U.S. Application Data
(60) Provisional application No. 62/001,536, filed on May 21, 2014.

(51) Int. Cl. G02C 11/00

(52) U.S. Cl. CPC G02C 11/00

(57) ABSTRACT

The present invention provides a spring clip attachable to either temple piece of a pair of eyeglasses. The spring clip can be used to secure the eyeglasses to clothing. The spring clip has a pair of spring clamps that fit over either temple piece of a pair of eyeglasses, as well as a clip that can secures the eyeglasses to clothing. The pair of spring clamps are large enough to accommodate temple pieces having a wide range of thicknesses. The spring clip is formed from a spring steel blank in a bending process that forms the clamps and the clip. The clip can fabricated from stainless spring steel, or the clip can be fabricated from non-corrosion resistant spring steel and plated with a corrosion-resistant metal, such as gold or chromium.

### FIELD OF THE INVENTION

The present invention relates to eyeglass clip accessories for attaching eyeglass frames to garments, such as shirt pockets or belts and methods of manufacturing and using the same.

### BACKGROUND OF THE INVENTION

While some people wear glasses constantly, others wear them only intermittently or change from clear to tinted glasses depending on the ambient light conditions. It is desirable to have a clip attached to a temple bar of the glasses to engage the edge of a garment, such as a shirt pocket or belt, thereby preventing the folded glasses from falling out when bending over. Many attempts at the ideal design and method of this clip have been made over the years. Some involve modification of the temple bar or permanent attachment of the clip to the temple bar at the time of manufacture. Other attachable clips are cumbersome to mount, alter the appearance of the glasses substantially, involve expensive manufacture, provide non rigid attachment, or are conformable to a limited range of temple piece cross sections.

Among the prior art patents include U.S. Pat. No. 1,779,015 of Schmitt, which teaches temple clips that are either molded as one piece with the temple bar or attached by riveting or by a clamp form fit to the temple bar cross section. U.S. Pat. No. 1,898,059 of McDonald discloses a temple clip attached with a split barrel clamp and retained with a set screw. With respect to removable retrofit clips for eyeglass temple bars, U.S. Pat. No. 4,903,375 of DiFranco describes an inexpensive plastic clip which simply attaches to a variety of temple pieces through the use of two rubber “o” rings. This retrofit system of DiFranco '375 is not a rigid attachment however. Furthermore, U.S. Pat. No. 5,235,727 of McCloskey teaches several embodiments of an attachable pocket clip made of an elastically deformable material, such as a U-shaped spring steel clasp. Like DiFranco '375, McCloskey '727 does not teach a rigid attachment, and its U-shaped embodiment does not provide a secure fit. Different designs are used for different temple piece cross sections.

For example, McDonald '059 teaches attaching a retrofit clip to an eyeglass temple bar piece by an artificial, extra attachment member, such as a sleeve attached to the clip which slides over the temple bar piece. In addition, in Schmitt '015 the clip is attached either by rivets, or by an internal wire extending all the way through the temple bar piece and clip.

U.S. Pat. No. Des. 328,086 discloses an Eyeglass Clasp for Pocket Clip that uses a U-shaped clamp that fits over the temple piece of a pair of glasses. The clamp is held in place with a set screw.

Whenever there is an external piece such as the sleeve of McDonald '059 or the rivet of Schmitt '015, there is usually a protruding element which could scratch the wearer's skin or eyes. In addition, the longitudinally extending wire piece of Schmitt is difficult to manufacture, as the wire has to be imbedded within the temple bar piece.

Two European patents, namely Swiss patent no. 421,551 dated Sep. 30, 1966 of Albanesi and French patent no. 1,162,365 dated Nov. 2, 1958 of Boissot describe a clip molded with an eyeglass temple bar of an eyeglass frame. However, these two patents do not mention using particular types of thermoplastic resins or bendable metal alloys to ensure that the clips resist torsional (bending) stresses because of the constant on and off moving of the eyeglasses and clip to and from shirt pockets.

Moreover, U.S. Pat. Nos. 4,316,654 and 4,496,224, both of Allen, teach eyeglass frames with pocket clips where the frames themselves are manufactured with pocket clips attached to the rims of eyeglass lenses. U.S. Pat. No. 5,414,906 of Kren discloses an eyeglass storage clip attached to a temple piece with a dual barrel design. It consists of several parts and uses spring clips to attach to a garment or pocket.

The disadvantages of the prior art are either that the temple bar pocket clips are difficult to assemble or assemble when the eye glasses are manufactured, as in Schmitt '075, McDonald '059, Allen '654, Allen '224 or Kren '906, or that the retrof it configurations of DiFranco '375 or McCloskey '727 are flimsy and not designed for long term rigid attachments.

### SUMMARY OF THE INVENTION

The present invention provides a spring clip attachable to either temple piece of a pair of eyeglasses. The spring clip can be used to secure the eyeglasses to clothing. The spring clip has a pair of spring clamps that fit over either temple piece of a pair of eyeglasses, as well as a clip that can secures the eyeglasses to clothing. The pair of spring clamps are large enough to accommodate temple pieces having a wide range of thicknesses. The spring clip is formed from a spring steel blank in a bending process that forms the clamps and the clip. The clip can fabricated from stainless spring steel, or the clip can be fabricated from non-corrosion resistant spring steel and plated with a corrosion-resistant metal, such as gold or chromium.

### BRIEF DESCRIPTION OF THE DRAWINGS

FIG. 1 is an isometric view of a spring clip attachable to an eyeglass frame temple piece;

FIG. 2 is an isometric view of the spring clip of FIG. 1, showing the relative directions from which the views of FIGS. 3 through 8 are taken;

FIG. 3 is an front elevational view of the spring clip;

FIG. 4 is a rear elevational view of the spring clip;

FIG. 5 is a right end elevational view of the spring clip;

FIG. 6 is a left end elevational view of the spring clip;

FIG. 7 is a top plan view of the spring clip;

FIG. 8 is a bottom plan view of the spring clip;

FIG. 9 is a top plan view of the spring steel blank from which the spring clip is formed;

FIG. 10 is an isometric view of the spring clip attached to the temple piece of a pair of eyeglasses; and

FIG. 11 is an alternative isometric view of the spring clip attached to the temple piece of a pair of eyeglasses.

### PREFERRED EMBODIMENT OF THE INVENTION

The clothing securable spring clip attachable to either temple piece of a pair of eyeglasses will now be described in detail with reference to the attached drawing figures.

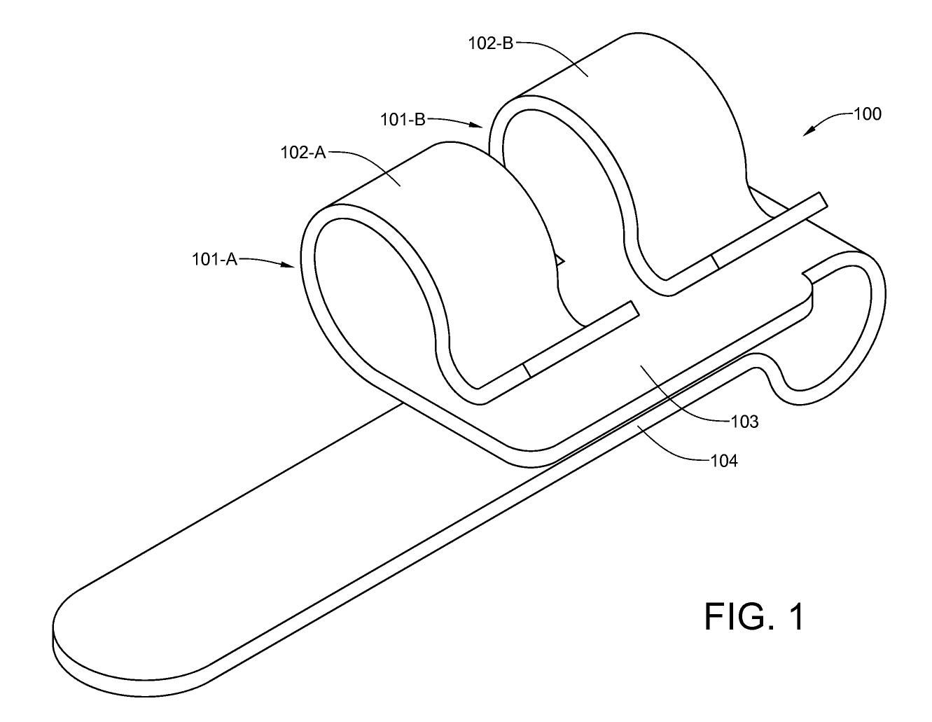

Referring now to FIG. 1, the spring clip 100 is formed from a single laminar blank that is bent to form a pair of side-by-side spring clamps 101-A and 101-B atop a single clothing clip 104. Each of the spring clamps 101-A and 101-B includes a semi-tubular portion 102-A and 102-B, respectively, as well as a planar laminar portion 103. The side adjacent the semi-tubular portion 102-A and 102-B is shared with the spring clamps 101-A and 101-B, while the opposite side of the planar laminar portion 103 is shared with the clothing clip 104. The spring clamps 101-A and 101-B are sufficiently large that they will accommodate temple pieces having a wide range of thicknesses. The spring clip 100 can fabricated from stainless spring steel, or the clip can be fabricated from non-corrosion-resistant spring steel and plated with a corrosion-resistant metal, such as gold or chromium.

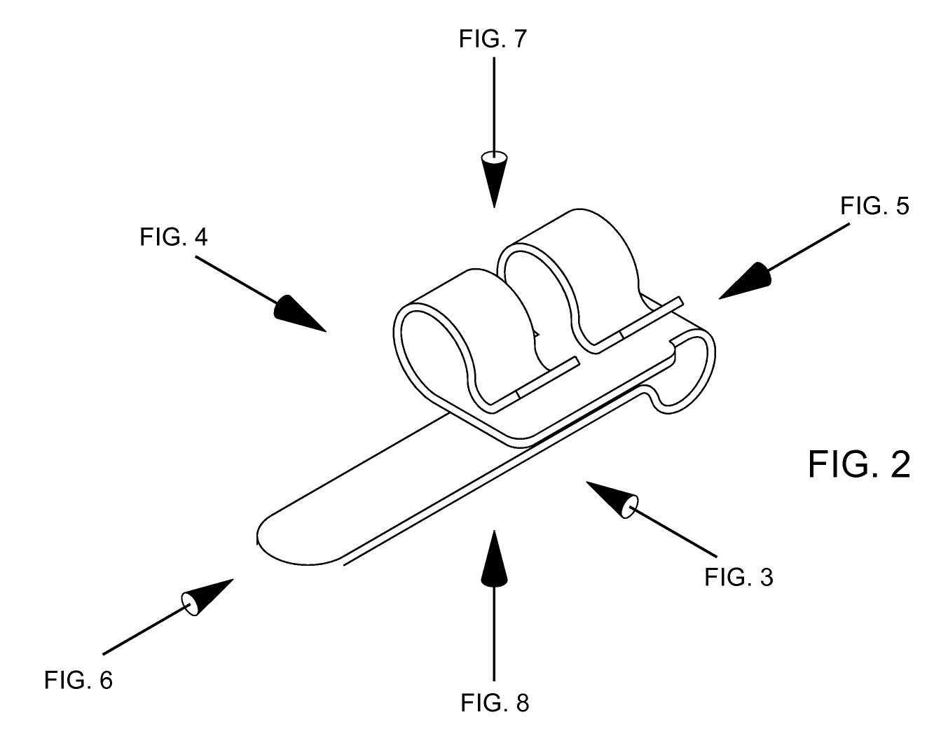

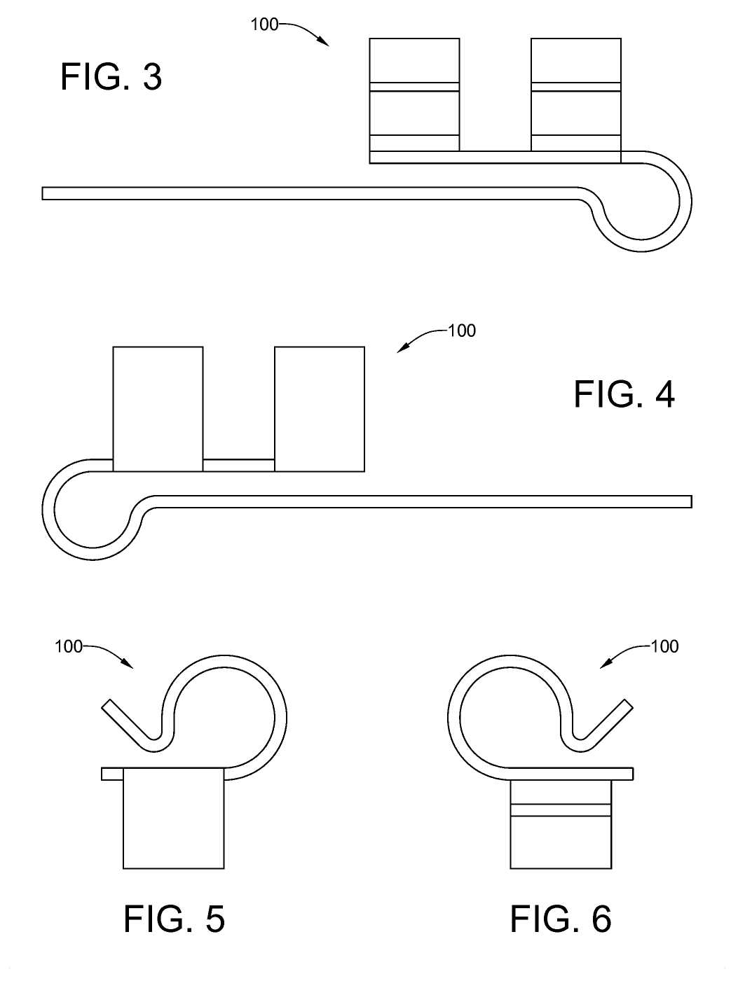

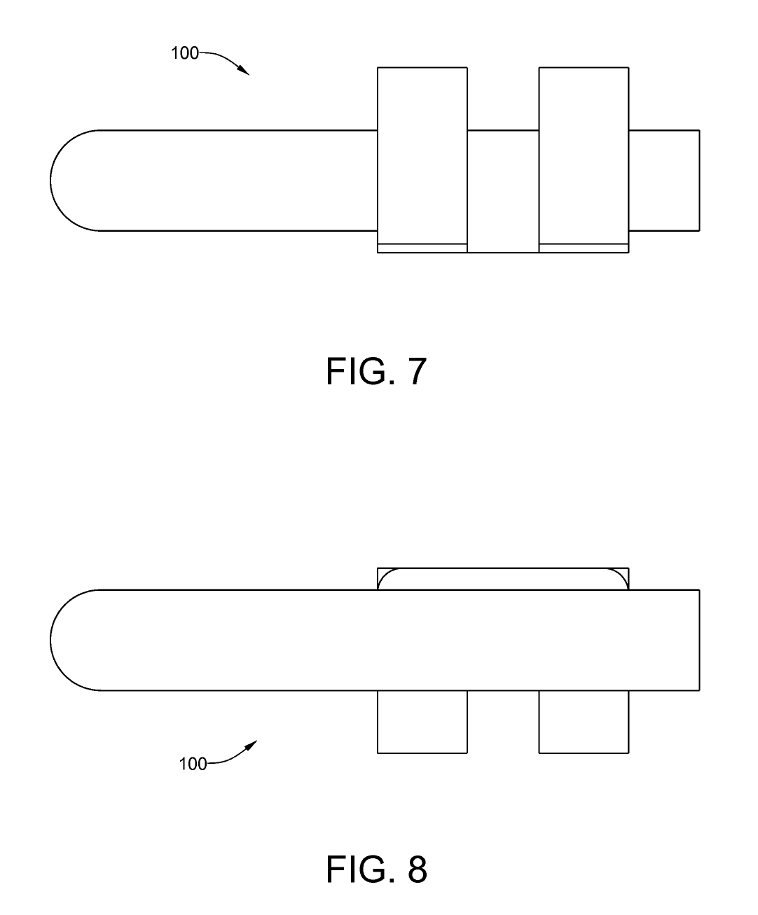

FIG. 2 shows the relative directions from which the plan and elevational views of FIGS. 3 through 8 are taken.

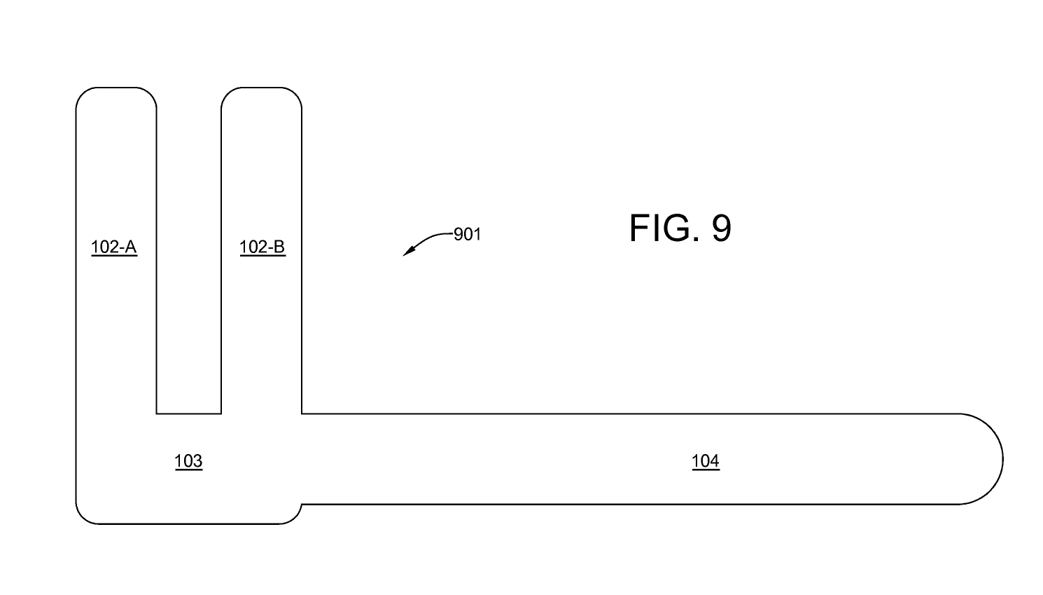

Referring now to FIG. 9, the spring clip 100 is formed from a single laminar blank 901 that is bent to form the pair of side-by-side spring clamps 101-A and 101-B atop a single clothing clip 104.

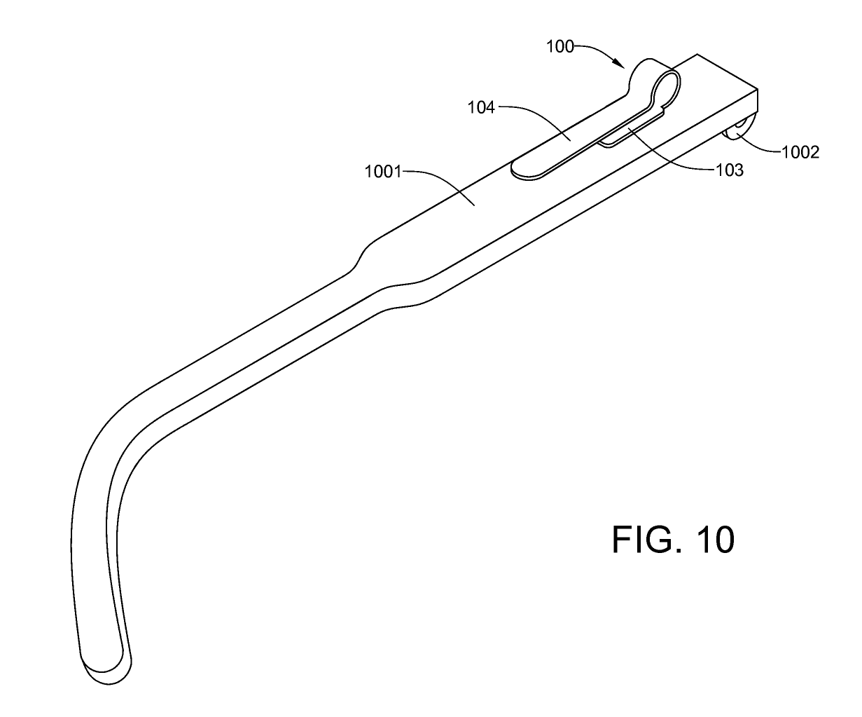

Referring now to FIG. 10, the spring clip 100 is shown mounted on the right temple piece 1001 of a pair of eyeglasses. The hinge of the temple piece 1002 is partially visible in this view. Only the clothing clip 104 and the shared laminar portion 103 are visible in this view.

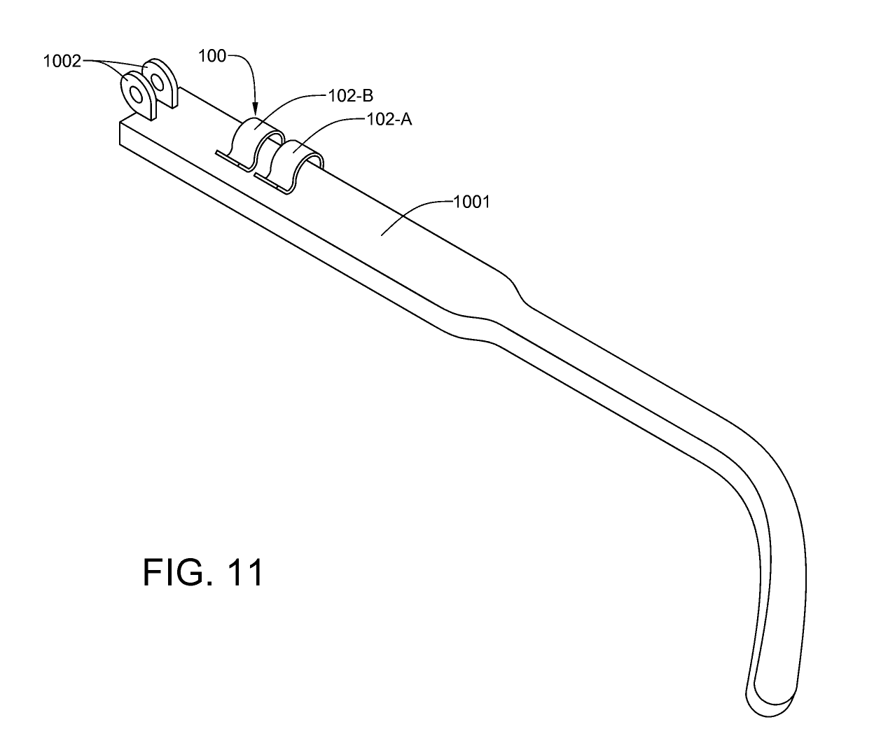

Referring now to FIG. 11, the spring clip 100 is shown mounted on the left temple piece 1001 of a pair of eyeglasses. The hinge of the temple piece 1002 is completely visible in this view. Only the spring clamps 101-A and 101-B of the spring clip 100 can be seen in this view. The clothing clip 104 of spring clip 100 enables a pair of eyeglasses to be secured to clothing.

The spring clip 100 is formed from a spring steel blank, as shown in FIG. 9, in a bending process that forms the clamps and the clip. The clip can fabricated from stainless spring steel, or the clip can be fabricated from non-corrosion resistant spring steel and plated with a corrosion-resistant metal, such as gold or chromium.

Although only a single embodiment of the spring clip attachable to either temple piece of a pair of eyeglasses has been shown and described, it will be obvious to those having ordinary skill in the art that changes and modifications may be made thereto without departing from the scope and the spirit of the invention as hereinafter claimed.

What is claimed is:

1. A spring clip attachable to a temple piece of a pair of eyeglass, said spring clip comprising:
a pair of spring clamps, each of which include a semi-tubular portion and a planar laminar portion, said planar laminar portion having opposed first and second parallel sides, a first side of which is functionally a part of both spring clamps; and
a clothes clip contiguous with and bent over the planar laminar portion, the second side of which is functionally a part of the clothes clip;
wherein said spring clamps, said planar laminar portion and said clothes clip are formed from a unitary piece of spring metal.
